(19) United States
(12) Patent Application Publication
(10) Pub. No.: US 2011/0031756 A1
(43) Pub. Date: Feb. 10, 2011

(54) SELF-STARTING DARRIEUS WIND TURBINE

(75) Inventor: Christopher W. Gabrys, La Pine, OR (US)

Correspondence Address: HOLLAND & HART, 222 South Main Street, Suite 2200, P.O. Box 11583, Salt Lake City, UT, 84110, US

(73) Assignee: WINDSPIRE ENERGY, INC., Reno, NV (US)

(21) Appl. No.: 12/747,154

(22) PCT Filed: Dec. 10, 2008
(86) PCT No.: PCT/US2008/013586

§ 371 Date: Oct. 25, 2010

Related U.S. Application Data
(60) Provisional application No. 61/007,282, filed on Dec. 12, 2007.

(51) Int. Cl. F03D 9/00

(52) U.S. Cl. 290/55

(57) ABSTRACT

A Darrieus rotor supported by a bearing system to rotate about a vertical axis for capturing wind energy has an alternator that is directly-driven by the rotor and converts rotational power from the rotor into electrical power. An electronic controller controls the electrical load applied to the alternator and the power output from the alternator to an output. The alternator is constructed having a substantially constant reluctance torque for all angular positions of rotation of the rotor. The bearing system includes upper and lower rolling element mechanical bearings that provide radial support of the rotor against wind load and axial support of the rotor, and a magnetic bearing that provides axial lift that reduces the axial load on the mechanical bearings and reduces the starting torque for rotating the rotor. The electronic controller applies minimal electrical load to the alternator until the rotor is at a rotational speed greater than a deadband for the rotor in the instantaneous wind speed, whereby the electronic controller, the alternator and the bearing system together avoid retarding forces that would otherwise prevent passive self-starting.

This invention relates to U.S. Provisional Application Ser. No. 61/007,282 filed Dec. 12, 2007 and titled “Vertical Axis Wind Turbine”. This invention pertains to a wind turbine and more particularly to a Darrieus wind turbine that is capable to passively self-start for power production. The wind turbine simplifies operation and construction, reduces costs, and increases annual energy generation through extended operation.

### BACKGROUND OF THE INVENTION

Interest in using renewable energy is steadily increasing. Key drivers pushing renewable energy growth are the world's gradual depletion of oil reserves and the increases in greenhouse gases from coal consumption that some believe to be jeopardizing the environment. The most rapidly growing types of renewable energy are solar and wind. Solar energy utilizes the energy from the sun and converts it into electrical power, most typically through use of photovoltaic panels. In contrast, wind energy is harnessed through the use of wind turbines having a rotor that is driven by the wind that in turn drives an electrical generator.

There are two types of wind turbines: HAWT (horizontal axis wind turbines) and VAWT (vertical axis wind turbines). HAWT's utilize a propeller that is attached to shaft for capturing energy from the wind. The propeller-driven shaft rotates about a horizontal axis and drives an electric generator. A yaw mechanism continually orients the axis and propeller into the wind for maximum energy capture. HAWT's are the conventional and most widely used wind turbine configuration. They operate at high tip speed ratios, which can result in loud noise, which can be offensive to neighbors. However, the HAWT configuration can achieve high energy capture efficiency and are very well suited for wind turbines, large and small, in sparsely populated or remote and or extreme wind areas.

VAWT's utilize a rotor attached to a shaft that rotates about a vertical axis. They generally operate at lower tip speed ratios than HAWT's and can be quieter. Because VAWT's do not need to change orientation to track changes in wind direction, they generate power instantly from wind in any direction, regardless of sudden changes in wind direction. VAWT's are more attractive and they are much better suited for wind energy generation in areas where people live and work.

There are two basic types of VAWT's: Darrieus and Savonius. Darrieus rotors utilize airfoil-profiled blades, similar to HAWT propeller blades. They can achieve high energy capture efficiency through the use of aerodynamic lift and have reduced wind load. Savonius and similar variation rotors utilize vanes of sheet material. The vanes capture wind energy principally through use of aerodynamic drag. Savonius rotors allow very simple construction and provide very high starting torque. However, they have lower energy capture efficiency and because of the greater vane area, they have increased wind loads. These deficiencies have usually tended to make the Savonius version of VAWT to be less cost effective solution than a Darrieus version.

Despite the high efficiency of Darrieus wind turbines, they currently suffer from a very significant deficiency. Darrieus wind turbines typically cannot self-start. They must utilize an added control system to sense wind speed and actively motor to accelerate the rotor to power production speeds, whenever adequate wind is present. The control system and motor function add considerable costs and they consume sizeable excess energy for operation especially in changing or low wind conditions. Furthermore, the inability to passively self-start reduces the average annual time spent producing power. Accordingly, a new Darrieus wind turbine that can passively self-start is needed.

### SUMMARY OF THE INVENTION

The invention provides a Darrieus wind turbine that is capable to passively self-start for power production. Passive self-starting is defined as the ability of a wind turbine to start rotation up to power production speeds solely by aerodynamic forces on the rotor, when exposed to wind speeds in the power production range. No external electrical power is utilized to accelerate the turbine rotor of a passively self-starting wind turbine.

It is well known in the art of wind turbine technology that Darrieus turbines typically do not have the ability to self-start. This is a significant deficiency, limiting their use. Through much effort, we have surprisingly found that Darrieus wind turbines' inability to self-start is not necessarily because of a complete deficit of rotor torque, when at zero or low rotational speeds in low wind. A Darrieus rotor may exhibit an extremely small positive torque even in these conditions. However, this torque is not nearly great enough to accelerate the turbine rotor up to power production speed. Because of this fact, it would be theoretically possible for a Darrieus rotor to be designed to self-start, if no frictional drag or other retarding forces existed.

Thus, it is the goal of the invention to enable the small rotor torque to accelerate the Darrieus rotor to power production speed through the careful reduction of frictional drag and the other retarding forces. As a result, we have found that a reliable and economically practical self-starting Darrieus wind turbine can in fact be created through the combination of elements and construction as will be described.

The self-starting Darrieus wind turbine comprises a Darrieus rotor, and an alternator, electronic controller and a bearing system that cooperate to facilitate passive self-starting. The Darrieus rotor is supported by the bearing system to rotate about a vertical axis for capturing wind energy. The alternator is directly-driven by the Darrieus rotor and converts rotational power from the Darrieus rotor into electrical power, whereby the electronic controller controls the electrical load that is applied to the alternator and the power that is delivered to an output. The alternator is constructed of a permanent magnet rotor and an aircore armature, wherein magnets on the permanent magnet rotor drive magnetic flux across an armature airgap, and the aircore armature is constructed of windings in a substantially non-ferromagnetic structure where located inside the armature airgap. The bearing system comprises upper and lower rolling element mechanical bearings and a magnetic bearing. The mechanical bearings provide radial support of the Darrieus rotor against wind load and axial support of the rotor. The magnetic bearing provides axial lift that reduces the weight on the mechanical bearings and reduces the starting torque for rotating the Darrieus rotor. The electronic controller further applies substantially no electrical load to the alternator until the Darrieus rotor is at a rotational speed greater than the deadband for the Darrieus rotor in the instantaneous wind speed.

The alternator of the wind turbine is directly-driven by the Darrieus rotor without the use of a transmission and its friction losses. The alternator is constructed to have very little and more preferably zero cogging. Cogging is the tendency for an alternator to have preferred rotational positions of magnetic attraction between the rotor and stator that impede rotation. Air core construction is used to eliminate cogging. The armature windings are wound and supported in a substantially non-ferromagnetic structure. Without magnetic attraction between the alternator rotor and stator, cogging and alternator forces that work against turbine self-starting are precluded. Other means for reducing cogging could also be utilized, such as skewed stators, but with less effectiveness. In general, the goal for the alternator to have a substantially constant reluctance torque for all angular positions of rotation of the rotor. Preferably cogging torque is limited to less than 5% of rated torque and more preferably is zero.

Rolling element mechanical bearings provide support of the Darrieus rotor against the radial wind loads and some axial support of the rotor weight. The axial magnetic bearing removes the majority of the axial load from the mechanical bearings. A magnetic bearing system alone, without mechanical bearings, would provide the lowest possible friction, however we have found this construction to be impractical to resist the high wind loading, and would be costly. Starting friction is reduced in the wind turbine in low wind when starting is most difficult, because there are very low radial loads exerted by the light winds that must be carried by the mechanical bearings. At the same time, the magnetic bearing carries the majority of the rotor weight (axial loading) to substantially reduce friction. The mechanical bearings essentially carry almost no radial or axial loads in the conditions of low wind. A small axial load on the mechanical bearings is used to stabilize the magnetic bearing and preclude the need for complex, costly and less reliable active electronic control systems. The axial load on the mechanical bearings can be reduced by as much as a factor of 20 to assist the self-starting.

Darrieus rotors, especially in low wind conditions, can further exhibit a deadband, or range of operating tip speed ratios where the rotor's torque becomes very small. There may be sufficient wind for generating useful energy if the rotor can accelerate to power production speeds. However, if the rotor cannot get up to speed, then it will not develop sufficient torque for power production. To further assist the self-starting, the electronic controller does not apply any load to the alternator that would tend to inhibit acceleration, until the rotor reaches a speed that is faster than the deadband for the rotor in the lowest production wind speed.

The magnetic bearing that removes the majority of axial load from the mechanical bearings can have several different constructions. It can be constructed from two magnets to form a repulsive lift bearing or can use one or more magnets and a ferromagnetic yoke to create an attractive lift magnetic bearing. We have found that an attractive arrangement magnetic bearing can provide more than twice the lifting force capability per magnet size compared to a repulsive lift version and has benefits of lower costs and size. An attractive magnetic bearing can be constructed as a permanent magnetic bearing or an electromagnetic bearing. The use of a permanent magnet for the field flux is preferred because it allows for a larger magnetic airgap and physical clearance. This allows for reduced machining tolerances and alleviates concerns about mechanical deflections of assemblies during the turbine operation. The use of a permanent magnet further simplifies operation and does not require power for operation. In one embodiment of the invention, the magnetic bearing provides axial lift through magnetic attraction between a permanent magnet and a ferromagnetic yoke. A completely defined magnetic path has been shown to provide the highest magnetic lift per assembly cost. Although the magnetic bearing can be constructed and installed by several means, it is would be desirable to preclude any possibility of human injury from magnetic forces. In an additional embodiment, the magnetic bearing is a single unit assembly prior to installation whereby axial force against the mechanical bearings from installation causes the magnetic bearing to form a magnetic airgap. In this construction, the magnetic bearing is magnetically shorted prior to installation. When tightened into place, the magnetic bearing is forced open to form its magnetic airgap.

The load on the mechanical bearings, which are required for handling the high radial wind load forces in storms, directly affects their friction and starting torque. In low wind conditions, the radial loads of the wind on the Darrieus rotor are small. The majority load is resultantly from the weight of the turbine rotor. The magnetic bearing is used to remove this load. The starting torque of the rotor is directly related to the axial loading on the mechanical bearings. In one embodiment, the magnetic bearing reduces the starting torque of the Darrieus rotor by more than 50%. More preferably, the installation of the magnetic bearing reduces the starting torque by 95%. To accomplish this reduction in starting torque, the magnetic bearing preferably carries a majority of the weight of the rotor, instead of the mechanical bearings. In an additional embodiment, the mechanical bearings carry an axial load that is less than 10% of the weight of the rotating mass of the Darrieus wind turbine.

Wind turbines are designed to harness wind energy over a range of wind speeds. Typically, wind turbines are rated by their power production capability when in a wind speed of 11 m/s. On the low end, wind turbines are usually designed to start producing power when in a wind speed of 4 m/s. Below 4 m/s wind speeds, there is not enough energy worth trying to extract. Therefore, it is desirable to be able to start power production when exposed to wind of 4 m/s and greater. In an additional embodiment, the

Darrieus rotor is capable to passively accelerate to a tip speed ratio greater than 1.5 in wind speeds of 6 m/s or less. More preferably, the turbine rotor is able to accelerate to a tip speed ratio greater than 1.5 in wind speeds as low as 4 m/s.

There are many possible configurations for the construction of a Darrieus wind turbine. These configurations include shafts, bearing locations and the generator position. Traditional Darrieus turbines have utilized a bearing at the top of the rotor shaft and guy wires for upper support. The design of a wind turbine can be very detailed with many considerations. Some configurations can provide additional benefits and cost savings that might not be expected. In an additional embodiment, the alternator is located axially in between the Darrieus rotor and the upper mechanical bearing. With two mechanical bearings below the alternator and the Darrieus rotor, the alternator can easily be constructed as an outside rotor topology. In contract with most electrical machines, the rotor can be made to rotate about a center stator. The benefits of this construction include a higher magnet speed and lower costs per power rating.

Even with a very low friction bearing system and a low or zero cogging alternator, sufficient retarding torque may exist to prevent a Darrieus wind turbine from self-starting. Darrieus wind turbine rotor aerodynamics is quite complex. Darrieus rotors are influenced by a number of parameters including airfoil thickness, rotor solidity, camber and tow angle. Each of these parameters can be adjusted to increase the small but positive torque that the rotor can generate in low wind speeds. In many cases, the Darrieus rotor exhibits a deadband, or a tip speed ratio range in a given wind speed, that has very small torque generation. If the rotor can be accelerated past the deadband speed range, then it can start useful power production, but if not, it may only rotate slowly and not provide any benefits. In an additional embodiment, the electronic controller assists the starting process. The electronic controller delivers no power, or substantially no power, to the output until the Darrieus rotor is at a rotational speed greater than the deadband for the Darrieus rotor in the instantaneous wind speed. In other words, the electronic controller applies substantially no electrical load to the alternator. The rotor dead bands are most prevalent at the lower wind speeds. The rotational frequency of the rotor to get past the deadband in the lowest production wind speed is therefore set as the starting rotor speed for the electronic controller to begin harnessing energy.

### DESCRIPTION OF THE DRAWINGS

The invention and its many advantages and features will become better understood upon reading the following detailed description of the preferred embodiments in conjunction with the following drawings, wherein:

FIG. 1 is a schematic elevation of residential wind turbine energy installation in accordance with the invention.

FIG. 2 is a schematic plan view of the wind turbine rotor of the self-starting wind turbine shown in FIG. 1.

FIG. 3 is a schematic crosses-sectional elevation of the alternator and upper bearing section of the self-starting wind turbine shown in FIG. 1.

FIG. 4 is a comparison plot of the cogging torque between a conventional slot wound alternator and an air core alternator in a self-starting wind turbine in accordance with the invention.

FIG. 5 is a schematic sectional elevation of the lower bearing section of the self-starting wind turbine shown in FIG. 1.

FIG. 6 is a comparison plot of the axial loading on the rolling element mechanical bearings in a wind turbine both with and without the magnetic bearing in accordance with the invention.

FIG. 7 is a plot of the power coefficient versus rotor tip speed ratio in 4 m/s wind for a self-starting wind turbine in accordance with the invention.

FIG. 8 is a plot of the power coefficient versus rotor tip speed ratio in 10 m/s wind for a self-starting wind turbine in accordance with the invention.

FIG. 9 is a plot of the electronic controller power versus speed control of the self-starting wind turbine shown in FIG. 1.

FIG. 10 is a comparison bar graph of the wind turbine starting torque between a conventional wind turbine and a self-starting wind turbine in accordance with the invention.

FIG. 11 is a comparison bar graph of the wind turbine starting wind speed between a conventional wind turbine and a self-starting wind turbine in accordance with the invention.

FIG. 12 is a comparison bar graph of the annual energy generation in a Class 3 wind regime between a conventional wind turbine and a self-starting wind turbine in accordance with the invention.

FIG. 13 is a comparison bar graph of the annual energy generation in a Class 4 wind regime between a conventional wind turbine and a self-starting wind turbine in accordance with the invention.

### DESCRIPTION OF THE PREFERRED EMBODIMENTS

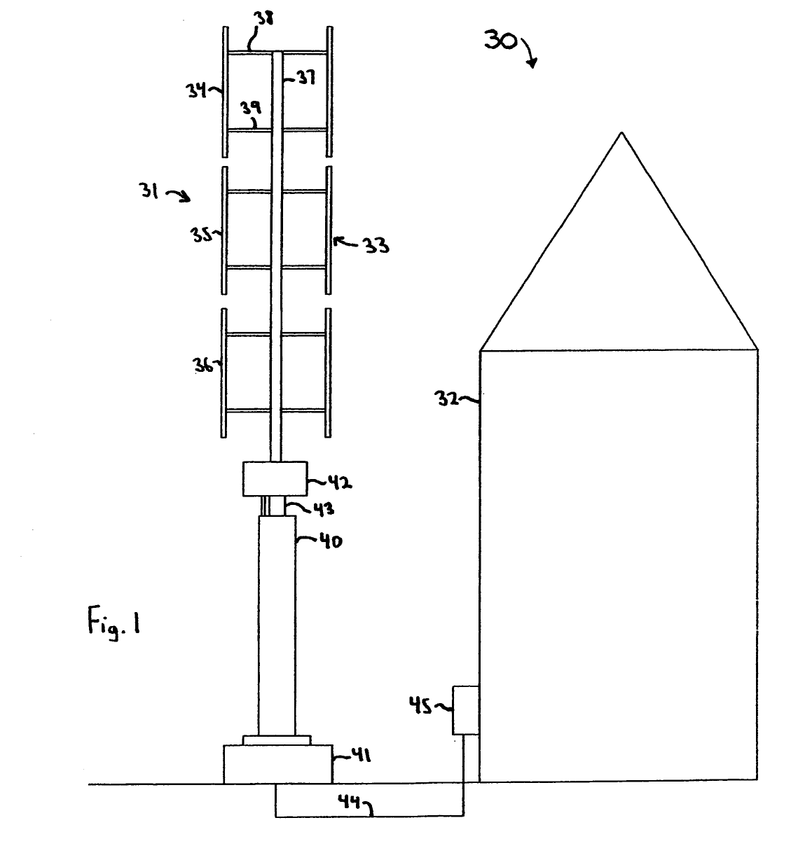

Turning to the drawings, wherein like reference characters designate identical or corresponding parts, FIG. 1 shows a residential wind turbine energy installation in accordance with the invention. The installation 30 is comprised of a self-starting Darrieus wind turbine 31 and a house 32. The turbine 31 is constructed of a rotor 33 with airfoils 34 that are attached to a center shaft 37 through struts 38 and 39. Although the Darrieus rotor can be a curved troposkein, the rotor shown is a straight bladed Darrieus, or giromill. A giromill is preferable in many cases because it provides a greater rotor swept area for energy capture per the rotor diameter. The rotor 33 shown is made of three rotor sections 34, 35, 36 although a single rotor section could also be used instead if it were properly designed to handle rotational and bending stresses. The shaft 37 directly drives a generator 42 that is attached to a base pole 40 through a stator tube 43. The base pole 40 is supported by a concrete foundation 41 to remain upright. A power connection 44 supplies electrical power from the turbine 31 to the house 32. A disconnect switch 45 is provided to allow the wind turbine 31 to be shut off.

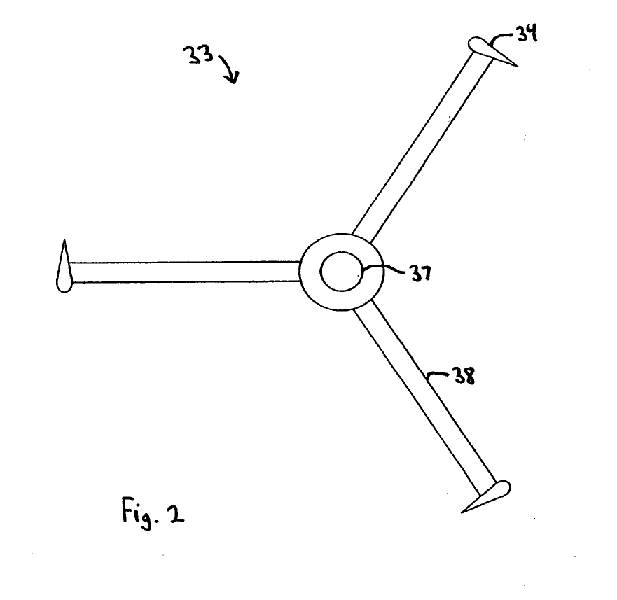

The wind turbine rotor 33 is shown from above in FIG. 2. The Darrieus rotor 33 is constructed of three equal-spaced airfoils 34 that attach to the top shaft 37 through the struts 38. The airfoils 34 may be constructed from composite materials such as fiberglass epoxy, or more preferably from extruded aluminum for low cost. Although shown with three blades, the rotor may be constructed of only two or alternatively of more than 3. Use of three blades generally helps increase the starting torque of the rotor 33 compared with two blades.

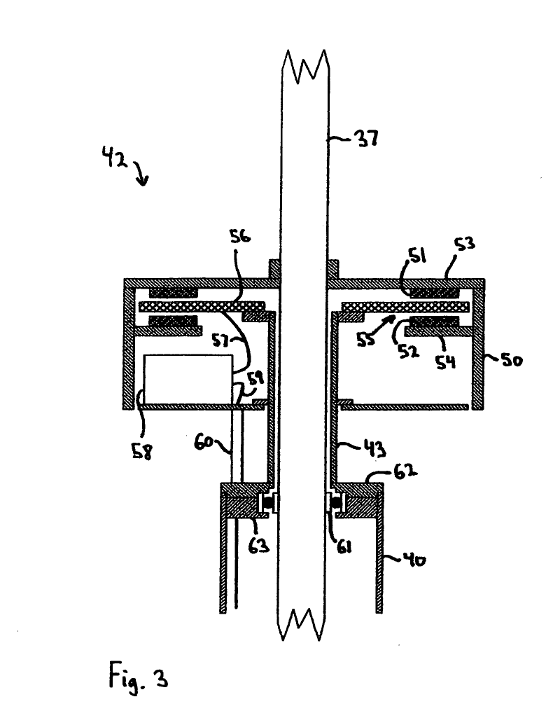

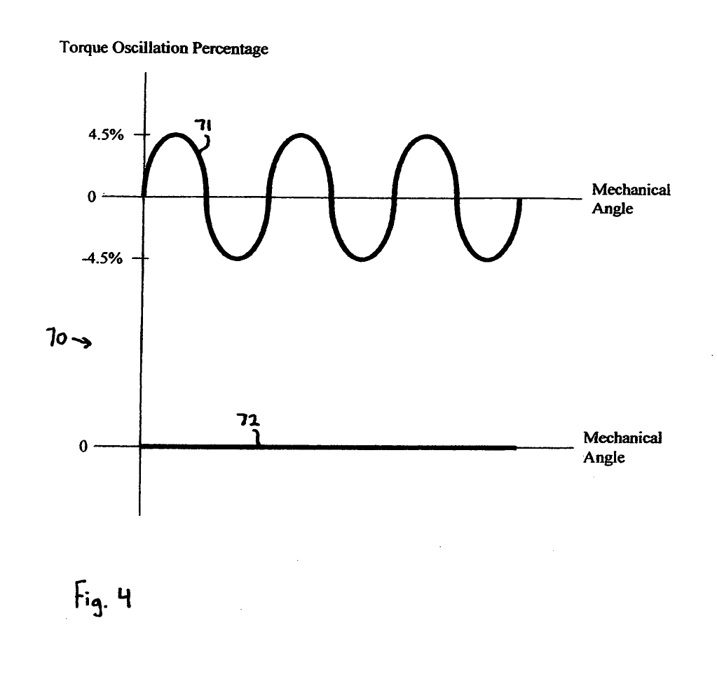

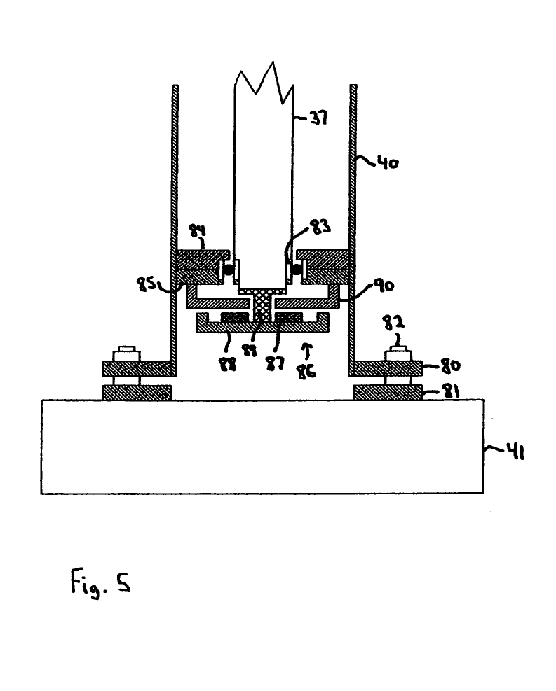

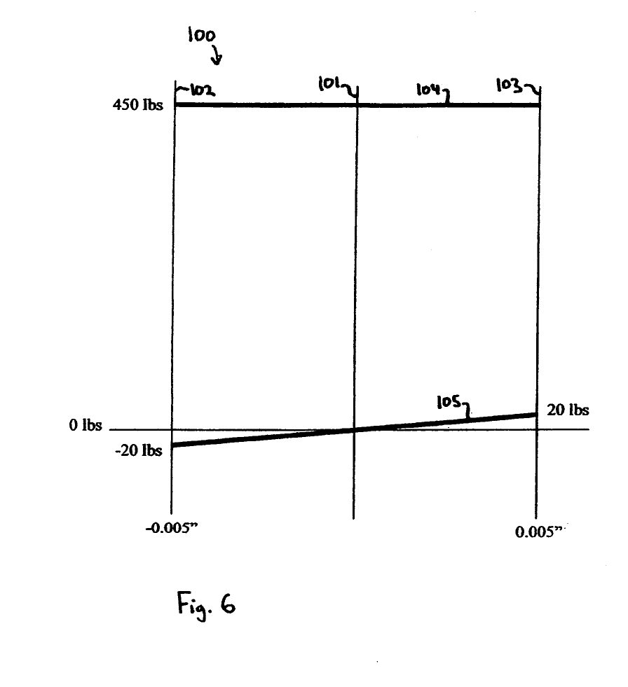

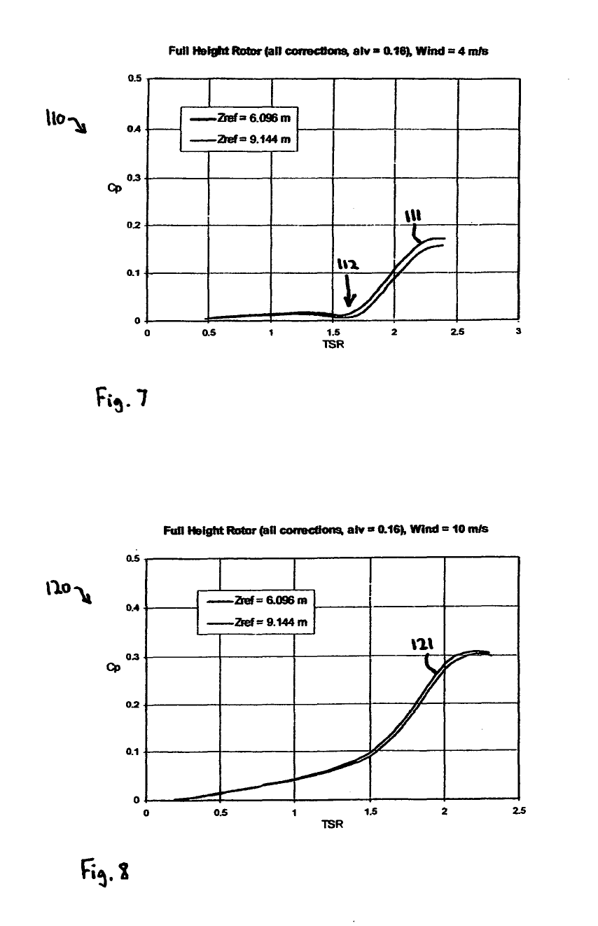

The alternator and upper bearing section of the self-starting wind turbine is shown in FIG. 3. The alternator 42 is directly driven by the rotor center shaft 37, which is journaled for rotation in the top of a base pole 40 by an upper bearing 61. The upper bearing 61 is attached to the base pole 40 through upper and lower bearing clamping plates 62, 63. The alternator 42 is constructed from two axially spaced apart annular arrays 51, 52 of circumferentially alternating permanent magnets. The magnets 51, 52 are attached to steel backiron plates 53, 54 to form an armature airgap 55 between the magnets 51, 52. The backirons 53, 54 are held in position by an outer housing 50 that also rotates with the shaft 37. A donut-shaped air core armature 56 is located in the armature airgap 55 and is supported by the stator tube 43. The air core armature comprises copper windings that are held together by plastic to form a rigid and substantially nonmagnetic structure. The air core armature 56 thereby exhibits no magnetic attraction to the magnet arrays 51, 52. The magnet arrays 51, 52 drive magnetic flux back and forth through the air core armature. As the alternator 42 spins, unregulated power is produced in the windings of the aircore armature 56. The unregulated power is coupled via an electrical conductor 57 to an electronic controller 58. The controller 58 is commercially available from several specialized companies and can be designed to control the electrical load to the air core armature 56 and also in turn the power output 59. The output power 59 is fed into the base pole 40 through a wire conduit 60, and thence to the electrical connection 44.

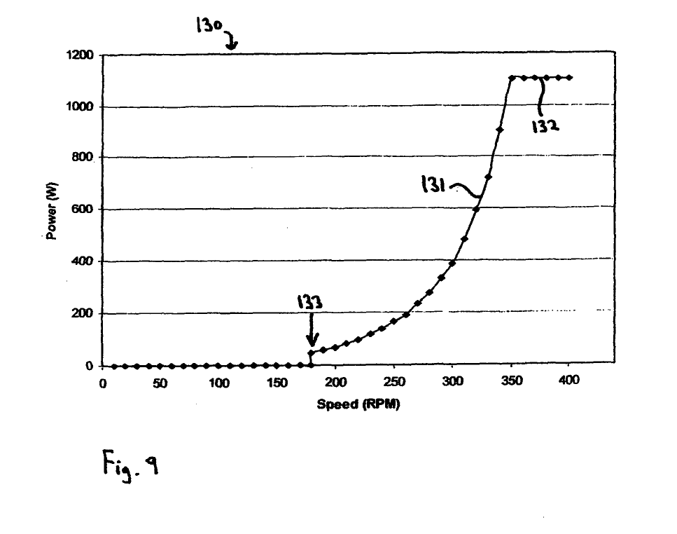

Other types of generators could also be utilized as long as they have very low cogging. Slot wound alternators with a skewed stator can be built to have reduced cogging. However, an air core generator is most preferable because it exhibits zero cogging and does not have magnetic hysteresis losses, both which would make the passive self-starting of the wind turbine more difficult. A comparison plot of the cogging torque between a conventional slot wound alternator and an air core alternator in a self-starting wind turbine is shown in FIG. 4. The comparison 70 of the reluctance torque oscillation with variation of the mechanical angle of the rotor to stator is shown. The reluctance torque as a percentage of rated torque for a well designed slot wound alternator with a skewed stator, represented by the curve 71 in FIG. 4, is about 4.5%. This is much lower than an alternator without a skewed stator and allows easier rotation. An alternator that is constructed of a permanent magnet rotor and a stator with a cogging torque that is less than 5% of rated torque is desirable. However, the preferred alternator is the aircore configuration. The reluctance torque as a percentage of rated torque for an aircore alternator 72 is 0%. The stator is constructed without ferromagnetic material and hence there is no magnetic attraction between the rotor and stator. This fact eliminates the cogging torque as well as hysteresis losses. An alternator constructed having a substantially constant reluctance torque for all angular positions of rotation of the rotor is the preferred type.

The lower bearing section of the self-starting wind turbine is shown in FIG. 5. The base pole 40 is attached to the concrete foundation 41 through the use of foundation anchor bolts 82. The anchor bolts 82 pass through both upper and lower hinge plates 80, 81 that allow the wind turbine to be easily assembled on the ground and erected. The lower end of the shaft 37 is journaled for rotation by the lower mechanical bearing 83. The lower mechanical bearing 83 is held in place inside the base pole 40 by the upper and lower clamping plates 84, 85. The shaft is axially locked into place in the lower bearing 83 such that the lower bearing carries axial loading. Note that the upper mechanical bearing could alternatively be made to carry axially loading instead.

As shown in FIG. 5, a magnetic bearing 86 is used to reduce the axial load on the lower mechanical bearing 83 by more than 50% and preferably about roughly 95%. With the magnetic bearing 86, the mechanical bearings carry an axial load that is less than 10% of the weight of the rotating mass of the Darrieus wind turbine. The magnetic bearing 86 is constructed from a permanent magnet ring 87 that is held inside a steel cup 88. The cup 88 is attached to the lower end of the shaft 37 by an aluminum pushing rod 89. A steel yoke 90 is attached to the lower bearing clamping plate 85 and, with the cup 88, provides a closed magnetic loop for the magnetic bearing 86. As the magnet 87 and cup 88 are attracted to the yoke 90, an upward force is exerted on the shaft 37 through the pushing rod 89 to counter the weight of the Darrieus rotor on the lower bearing 83. This configuration of magnetic bearing is very desirable because of the maximum possible force per magnet material cost, lack of power consumption, simple installation and safety. The magnetic bearing 86 can be shipped as a single unit assembly, including the magnet 87, the cup 88, the pushing rod 89 and the yoke 90, all magnetically stuck together. When the yoke is bolted to the lower bearing clamping plate 85 during installation, force against the lower bearing 83 causes the magnetic bearing to open up and form its magnetic airgap.

A comparison of the axial loading on the rolling element mechanical bearings in a wind turbine both with and without the magnetic bearing is shown in FIG. 6. The comparison 100 shows the axial force on the lower mechanical bearing as a function of the axial displacement of the shaft. This displacement is plus or minus 0.005 of one inch and is the result of play in the lower mechanical bearing. The middle position 101 is with no axial load applied to the lower mechanical bearing while the lower displaced position 102 and upper displaced position 103 are 0.010 inches apart. For a wind turbine without the magnetic bearing installed, represented by the line 104, the force on the lower mechanical bearing is equal to the weight of the rotating mass or 450 lbs. The axial load does not change with position of the shaft. In contrast, the wind turbine with the magnetic bearing installed, represented by the line 105, carries a maximum axial load on the lower mechanical bearing of only 20 lbs. The shaft will either be displaced upward 0.005 inch and have a magnetic attractive force upward on the lower mechanical bearing of 20 lbs, or will be displaced downward 0.005 inch and have a rotor weight force downward of 20 lbs.

Particularly in low wind speeds, Darrieus wind turbine rotors can have a deadband or range of tip speed ratios (ratio of rotor peripheral speed divided by the wind speed) where they exhibit extremely small torque. A plot of the power coefficient versus rotor tip speed ratio in 4 m/s wind for a self-starting wind turbine in accordance with the invention is shown in FIG. 7. The plot 110 shows the rotor power coefficient profile 111 that peaks for the given rotor at a tip speed ratio (TSR) of about 2.3. Note that other rotor designs with different airfoils and dimensions will have a different power coefficient profile but nonetheless work the same. The profile 111 is shown for two heights of wind speed measurement above the ground denoted as Zref. The rotor exhibits a dead band 112 that concludes at a tip speed ratio of slightly over 1.5 when exposed to wind at 4 m/s. The rotor must be able to accelerate past this tip speed ratio in order to be able to start power production.

The power coefficient versus rotor tip speed ratio in 10 m/s wind for a self-starting wind turbine in accordance with the invention is shown in FIG. 8. The plot 120 shows the power coefficient profile 121 for two heights of wind speed measurement above the ground. As can be seen, the rotor does not exhibit a deadband in high winds. Although this would tend to make it easier for the wind turbine to passively self-start, it does not solve the problem. The turbine needs to be able to self-start even in low winds or it would miss significant energy capture potential. The wind turbine further needs to be able to self-start in winds that are in the power production range. For most wind turbines, the designed power production starts at about 4 m/s wind speed.

A plot of the electronic controller power versus speed control of the self-starting wind turbine is shown in FIG. 9. To assist the wind turbine to self start, it is critical that the rotor be able to accelerate past the deadband for the instantaneous wind speed. The plot 130 shows the power control curve 131 of the electronic controller. The electronic controller will measure the rotor speed and will apply the corresponding power load which is delivered to the output. The controller will apply substantially no load and deliver substantially no power to the output until the rotor speed is above the deadband for the rotor in the instantaneous wind speed. This is accomplished by not loading the rotor until a minimum rotor rpm 133. The minimum rotor rpm corresponds to being above at a tip speed ratio that is above the deadband for the lowest wind speed in the power production range. For a 1.22 m diameter rotor shown in 4 m/s wind, the deadband was shown to be slightly greater than a tip speed ratio of 1.5. However, the electronic controller waits to extract power until the rotor is above the deadband or at a tip speed ratio of 2.87. This occurs at the minimum rotor rpm 133 that is equal to 180 rpm for the turbine example. By this means, the electronic controller and generator together to not apply retarding forces that would prevent passive self-starting.

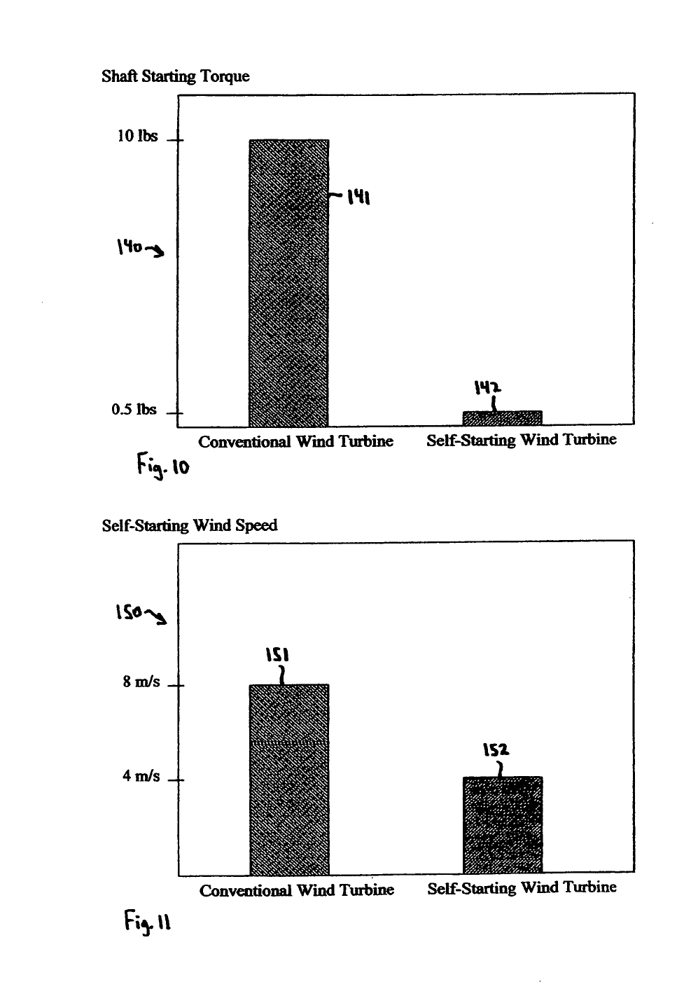

A comparison bar graph of the wind turbine starting torque between a conventional wind turbine and a self-starting wind turbine in accordance with the invention is shown in FIG. 10. The comparison shows that the starting torque required to start rotation of the rotor is substantially reduced. The conventional wind turbine has a starting torque, measured as a force applied to the outer diameter of a 3.5 inch rotor shaft to start rotation, of rough 10 lb-ft. In contrast, the self-starting wind turbine has a starting torque that is reduced to only 0.5 lb-ft, or a factor of 20 difference.

A comparison bar graph of the wind turbine starting wind speed between a conventional wind turbine and a self-starting wind turbine in accordance with the invention is shown in FIG. 11. The comparison 150 shows the wind speed at which the turbine rotor will passively accelerate to power production speeds. The conventional wind turbine 151 will self start in wind speeds of about 8 m/s. As a result, the wind turbine would typically include a motoring function to actively start so as not to miss significant energy generation potential. The added motoring capability adds substantially to the manufacturing and operating cost of the wind turbine. In contrast, the self-starting wind turbine 152 passively self-starts in 4 m/s, the lower limit for useable wind energy. The Darrieus rotor is capable to passively accelerate to a tip speed ratio greater than 1.5 in wind speeds of 6 m/s or even less, down to 4 m/s.

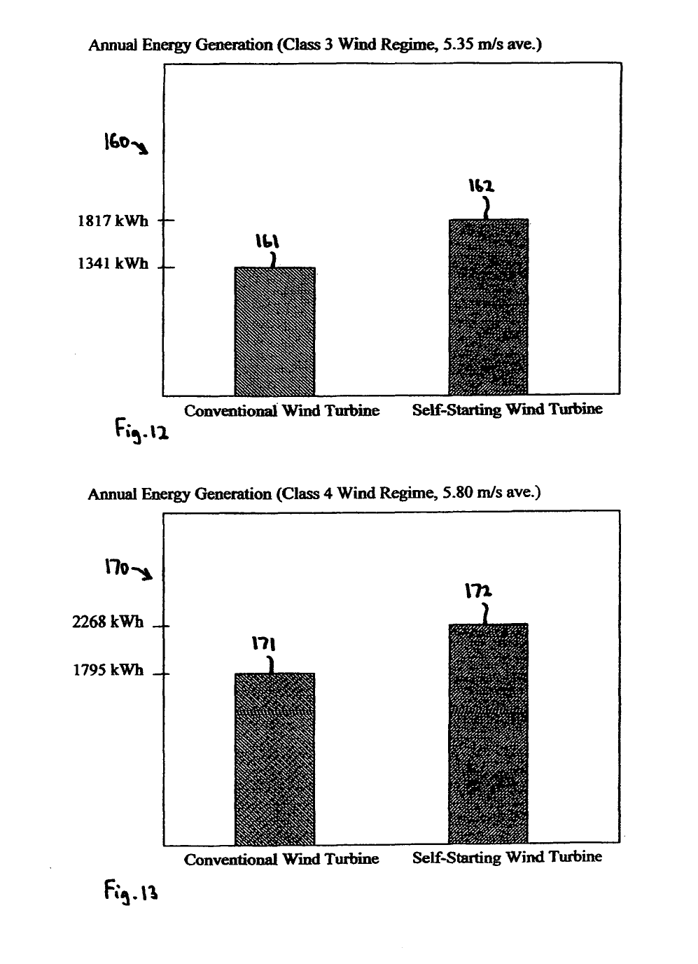

Because the self-starting wind turbine is capable to start in lower wind speeds, it is able to capture a greater amount of annual wind energy compared to a conventional Darrieus wind turbine that also does not have motor starting. Comparison bar graphs of the annual energy generation for 1 kW turbines in a Class 3 and Class 4 wind regimes are shown in FIG. 12 and FIG. 13. In the Class 3 wind regime 160, or 5.35 m/s average annual wind speed location, the conventional turbine provides 1341 kWh per year. The self-starting wind turbine provides 1817 kWh per year. In the Class 4 wind regime 170, or 5.80 m/s average annual wind speed location, the conventional turbine provides 1795 kWh per year while the self-starting wind turbine provides 2268 kWh per year.

Obviously, numerous modifications and variations of the described preferred embodiment are possible and will occur to those skilled in the art in light of this disclosure of the invention. Accordingly, I intend that these modifications and variations, and the equivalents thereof, be included within the spirit and scope of the invention as defined in the following claims, wherein

I claim:

1. A Darrieus wind turbine that is capable of passively self-starting by aerodynamic forces comprising:
a Darrieus rotor that is supported by a bearing system to rotate about a vertical axis for capturing wind energy;
an alternator that is directly-driven by said Darrieus rotor and converts rotational power from said Darrieus rotor into electrical power;
an electronic controller for controlling the electrical load applied to said alternator the power output from said alternator to an output;
said electronic controller, said alternator, and said a bearing system cooperate to facilitate said passive self-starting;
said alternator is constructed of a permanent magnet rotor and an aircore armature, wherein magnets on said permanent magnet rotor drive magnetic flux across an armature airgap, and said aircore armature is constructed of windings in a substantially non-ferromagnetic structure where located inside said armature airgap;
said bearing system comprises upper and lower rolling element mechanical bearings and a magnetic bearing;
said mechanical bearings provide radial support of said Darrieus rotor against wind load and axial support of said rotor;
said magnetic bearing provides axial lift that reduces the axial load on said mechanical bearings and reduces the starting torque for rotating said Darrieus rotor;
said electronic controller applies substantially no electrical load to said alternator until said Darrieus rotor is at a rotational speed greater than a deadband for said Darrieus rotor in the instantaneous wind speed.

2. A Darrieus wind turbine as described in claim 1 wherein:
said magnetic bearing provides axial lift through magnetic attraction between a permanent magnet and a ferromagnetic yoke.

3. A Darrieus wind turbine as described in claim 2 wherein:
said magnetic bearing is a single unit assembly prior to installation whereby axial force against said mechanical bearings from installation causes said magnetic bearing to form a magnetic airgap.

4. A Darrieus wind turbine as described in claim 1 wherein:
said magnetic bearing reduces said starting torque of said Darrieus rotor by more than 50%.

5. A Darrieus wind turbine as described in claim 1 wherein:
said mechanical bearings carry an axial load that is less than 10% of the weight of the rotating mass of said Darrieus wind turbine.

6. A Darrieus wind turbine as described in claim 1 wherein:
said Darrieus rotor is capable to passively accelerate to a tip speed ratio greater than 1.5 in wind speeds of 6 m/s or less.

7. A Darrieus wind turbine as described in claim 1 wherein:
said alternator is located axially between said Darrieus rotor and said upper mechanical bearing.

8. A Darrieus wind turbine that is capable of passively self-starting by aerodynamic forces comprising:
a Darrieus rotor, and an alternator, electronic controller and a bearing system that cooperate to facilitate said passive self-starting;
said Darrieus rotor is supported by said bearing system to rotate about a vertical axis for capturing wind energy;
said alternator is coupled to said Darrieus rotor and converts rotational power from said Darrieus rotor into electrical power, and said electronic controller controls the electrical load that is applied to said alternator and the power that is delivered to an output;
said alternator is constructed having a substantially constant reluctance torque for all angular positions of rotation of said rotor;
said bearing system comprises upper and lower rolling element mechanical bearings and a magnetic bearing;
said mechanical bearings provide radial support of said Darrieus rotor against wind load and axial support of said rotor;
said magnetic bearing provides axial lift that reduces the axial load on said mechanical bearings and reduces the starting torque for rotating said Darrieus rotor;
said electronic controller applies minimal electrical load to said alternator until said Darrieus rotor is at a rotational speed greater than a deadband for said Darrieus rotor in the instantaneous wind speed, whereby said electronic controller and alternator together avoid applying retarding forces that would otherwise prevent passive self-starting.

9. A Darrieus wind turbine as described in claim 8 wherein:
said magnetic bearing provides axial lift through magnetic attraction between a permanent magnet and a ferromagnetic yoke.

10. A Darrieus wind turbine as described in claim 9 wherein:
said magnetic bearing is a single unit assembly prior to installation, and axial force against said mechanical bearings from installation causes said magnetic bearing to form a magnetic airgap.

11. A Darrieus wind turbine as described in claim 8 wherein:
said Darrieus rotor comprises a giromill.

12. A Darrieus wind turbine as described in claim 8 wherein:
said mechanical bearings carry an axial load that is less than 10% of the weight of the rotating mass of said Darrieus wind turbine.

13. A Darrieus wind turbine as described in claim 8 wherein:
said Darrieus rotor is capable to passively accelerate to a tip speed ratio greater. than 1.5 in wind speeds of 6 m/s or less.

14. A Darrieus wind turbine as described in claim 8 wherein:
said alternator is located axially in between said Darrieus rotor and said upper mechanical bearing.

15. A Darrieus wind turbine that is capable of passively self-starting by aerodynamic forces comprising:
a Darrieus rotor, and an alternator, electronic controller and a bearing system that cooperate to facilitate said passive self-starting;
said Darrieus rotor is supported by said bearing system to rotate about a vertical axis for capturing wind energy;
said alternator is coupled to said Darrieus rotor and converts rotational power from said Darrieus rotor into electrical power, and said electronic controller controls electrical load that is applied to said alternator and the power that is delivered to an output;
said bearing system comprises upper and lower rolling element mechanical bearings and a magnetic bearing;
said mechanical bearings provide radial support of said Darrieus rotor against wind load;
said magnetic bearing provides axial lift that reduces starting torque for rotating said Darrieus rotor;
said electronic controller delivers substantially no power to said output until said Darrieus rotor is at a rotational speed greater than the deadband for said Darrieus rotor in the instantaneous wind speed.

16. A Darrieus wind turbine as described in claim 15 wherein:
said magnetic bearing provides axial lift by magnetic attraction between a permanent magnet and a ferromagnetic yoke.

17. A Darrieus wind turbine as described in claim 16 wherein:
said magnetic bearing is a single unit assembly prior to installation, and axial force against said mechanical bearings from installation causes said magnetic bearing to form a magnetic airgap.

18. A Darrieus wind turbine as described in claim 15 wherein:
said alternator is constructed of a permanent magnet rotor and a stator with cogging torque that is less than 5% of rated torque.

19. A Darrieus wind turbine as described in claim 15 wherein:
said Darrieus rotor is capable to passively accelerate to a tip speed ratio greater than 1.5 in wind speeds of 6 m/s or less.

20. A Darrieus wind turbine as described in claim 15 wherein:
said alternator is located axially in between said Darrieus rotor and said upper mechanical bearing
